(19) United States
(12) Patent Application Publication
(10) Pub. No.: US 2009/0282750 A1
(43) Pub. Date: Nov. 19, 2009

(54) Kitty blocker

(76) Inventor: Brian Kieth Arnold, Kansas City, KS (US)

Correspondence Address: Mr. Brian Kieth Arnold, 4654 Metropolitan, Kansas City, KS, 66106, US

(21) Appl. No.: 12/072,994

(22) Filed: May 17, 2008

(51) Int. Cl. A01K 29/00

(52) U.S. Cl. 52/101

(57) ABSTRACT

My invention is called the Kitty Blocker. The Kitty Blocker keeps cats from climbing Christmas trees, and trees with bird feeders or nests in them. The Kitty Blocker is made of two circles with mouth type openings on each circle that when put together it leaves an opening for a tree to go through the center. It also has strips of Velcro on each circle so that it can be adjusted to the size of the tree and will hold the circles firmly together.

The Kitty Blocker is an object that will block cats from climbing in trees. I came up with this invention so that I could stop my own cats from knocking down our Christmas tree and to keep them out of bird nests in the trees in the yard. This invention consists of two circles of thin material with mouth type opening on both pieces so that when the pieces are placed around a tree with the mouth type opening facing each other and then put together it leaves a hole up through the middle so that the tree trunk can go through it and then there are Velcro strips that fasten them together and also can be adjusted.

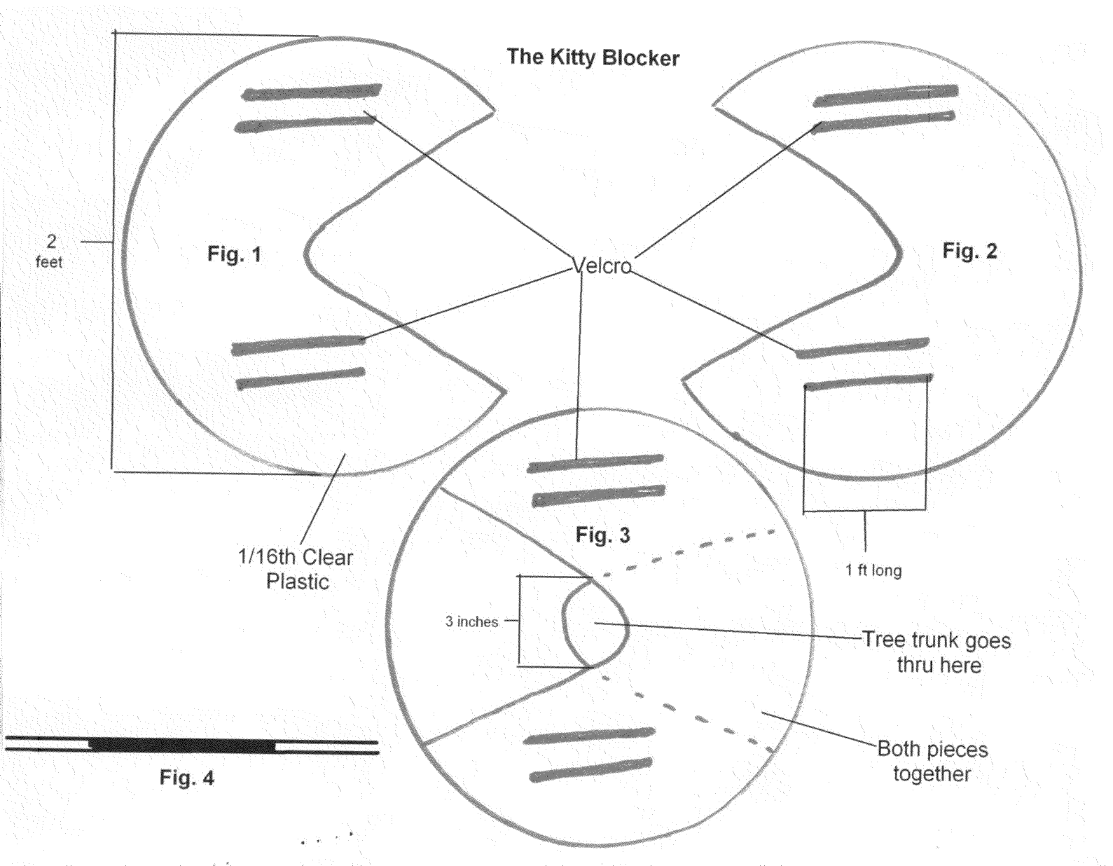

FIG. 1 is a front view of the first part of the invention showing my new design;

FIG. 2 is the second part and front view thereof;

FIG. 3 is the two parts together and a front view thereof;

FIG. 4 is the two parts together side view thereof;

I. I claim the apparatus that blocks animals from climbing trees consisting essentially of two pieces of round material that are placed around a tree and join together and leave an opening for the tree trunk in order to create a border around the tree trunk that blocks animals from climbing.

II. The apparatus that blocks animals recited in claim 1 wherein said two pieces of material that are placed around the tree have mouth type opening on both pieces.
